(19) United States
(12) Patent Application Publication
(10) Pub. No.: US 2008/0243707 A1
(43) Pub. Date: Oct. 2, 2008

(54) EQUIPMENT MANAGEMENT SYSTEM, EQUIPMENT MANAGEMENT APPARATUS, EQUIPMENT MANAGEMENT METHOD, AND COMPUTER READABLE STORAGE MEDIUM

(76) Inventor: Hiroaki HASEGAWA, Ohta-ku (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/057,864

(22) Filed: Mar. 28, 2008

(30) Foreign Application Priority Data
Mar. 29, 2007 (JP) 2007-089225

(51) Int. Cl. G06Q 10/00

(52) U.S. Cl. 705/80

(57) ABSTRACT

When product equipment is ordered, order list data configured to include an agreement ID and a product code is transmitted to a slip management server of a distribution company. The slip management server links a unit number to the product code, and stores the unit number and product code along with an agreement ID and status information indicating that the order has been placed in an equipment management table. In response to the order action, information that uniquely identifies the product is stored in the equipment management table.

### FIELD OF THE INVENTION

The present invention relates to an equipment management system, an equipment management apparatus, and an equipment management method configured to manage equipment products, from negotiations, through sale and operation, to disposal, and a computer readable storage medium configured to store a product management program.

### BACKGROUND OF THE INVENTION

Equipment products are managed from negotiations, through sale and operation, to disposal, using a plurality of management systems. For example, from negotiations to sale, i.e., from the moment a sales representative of a sales company begins negotiations with a customer until those negotiations are concluded, the management system of the sales company manages information including customer negotiations, the agreement(s) that result(s) in association thereto, and the target product(s) of the agreement. Additionally, the management system of the distribution company manages the quantity and serial numbers of products placed in a warehouse for inventory control of the equipment products and delivery of the products sold. The management system of the service company in charge of services associated with equipment maintenance, etc., in turn manages information from equipment delivery, through operation, to disposal, including the equipment serial numbers and services rendered. Depending on the type of operation, the information of the equipment may be managed by even a larger number of management systems.

For example, in Unexamined Japanese Patent Application KOKAI Publication No. 2006-323771, a system that notifies the user of the installation location of managed equipment and whether or not the equipment is currently in operation is disclosed.

However, each of the respective management systems of conventional technology stores and manages only the product information related to the work of that management system. As a result, in the event some kind of trouble arises with a certain product, investigating the information related to that product using the plurality of management systems is troublesome and time consuming. Further, information indicating the current status of the product is difficult to acquire, and maintaining statistics is impossible. Furthermore, because information is manually entered into each of the management systems, sometimes wrong information is entered or information of the same product is entered in each management system at different times.

### SUMMARY OF THE INVENTION

The present invention has been made in view of the above problems, and it is an object of the present invention to provide an equipment management system, etc., capable of managing a plurality of tasks related to equipment products, from business negotiations, through sale and operation, to disposal.

To achieve the above objective, an equipment management system according to a first aspect of the present invention comprises: a negotiations table configured to include a negotiations ID that uniquely identifies negotiations; an agreement table configured to include an agreement ID that uniquely identifies one or more agreements associated with one record of the negotiations table; an agreement product/service table configured to include a product code that uniquely identifies one or more products associated with one record of the negotiations table; an equipment management table comprising the agreement ID, the product code, a unit number of equipment which is the product, a status of the equipment, and a date as fields; an ordering unit configured to create order list data that includes the agreement ID and the product code; and a slip creating unit configured to create slip data from the order list data and link and store the agreement ID, the product code, and the corresponding unit number in the equipment management table.

The status of the equipment in the equipment management table may include an equipment operation status that indicates the operation status of equipment, and an equipment distribution status that indicates the transfer status of equipment, and the equipment management table may further include a field for an installation destination ID that indicates an installation destination of the equipment.

Further, an equipment management system according to a second aspect of the present invention further comprises: a database, a sales management computer, and a slip management computer, wherein: the database comprises a first table configured to register negotiations data including a negotiations ID that identifies negotiations; a second table that registers data of an agreement related to the negotiations in association with the negotiations ID, the data of an agreement including an agreement ID that identifies the agreement; and a third table that registers data of a product related to the agreement in association with the agreement ID, the data of a product including a product code that identifies the product; the sales management computer comprises a registration unit configured to register various information related to a product in the database, and a transmitting unit configured to transmit order data, including a product code of an ordered product, to a computer of a distribution company; and the slip management computer comprises an inventory control table configured to coordinate a unit number and a product code of an inventory product of a distribution company; a slip creating unit configured to respond to the reception of order data, read a unit number corresponding to the product code from the inventory control table, and write the unit number along with the product code to a slip table; and a unit number registration unit configured to add the unit number written to the slip table to product data that includes a product code corresponding to the unit number in the third table.

The product data may include information comprising at least an installation destination of the product, a status indicating the operation status, or a status indicating the distribution status.

Further, an equipment management apparatus according to a third aspect of the present invention comprises: a table configured to register negotiations data including a negotiations ID that identifies negotiations; a table configured to register data of an agreement related to the negotiations in association with the negotiations ID, the data of an agreement including an agreement ID that identifies the agreement; and a table configured to register data of a product related to the agreement in association with the agreement ID, the data of a product including a product code that identifies the product; wherein: the product data includes information comprising at least a number of each piece of equipment of the product, an installation destination of the product, a status indicating the operation status, or a status indicating the distribution status.

Further, an equipment management method according to a fourth aspect of the present invention is a method based on a database that stores a negotiations table configured to include a negotiations ID that uniquely identifies negotiations, an agreement table configured to include an agreement ID that uniquely identifies one or more agreements associated with one record of the negotiations table, an agreement product/service table configured to include a product code that uniquely identifies one or more products associated with one record of the agreement table, and an equipment management table comprising the agreement ID, the product code, a unit number of equipment which is the product, a status of the equipment, and a date as fields; comprising: an ordering step for creating and transmitting the order list data that includes the agreement ID and the product code; and a slip creating step for receiving the order list data, creating slip data from the order list data, and linking and storing the agreement ID, the product code, and the corresponding unit number in the equipment management table.

The status of the equipment in the equipment management table may include an equipment operation status that indicates the operation status of the equipment, and an equipment distribution status that indicates the transfer status of the equipment, and the equipment management table may further include a field for an installation destination ID that indicates an installation destination of the equipment.

Further, a computer readable recording medium according to a fifth aspect of the present invention stores a program configured to control a computer to execute: a step for responding to the reception of order data that includes a product code of an ordered product, reading a unit number corresponding to the product code from an inventory control table configured to coordinate a unit number and a product code of an inventory product of a distribution company, and writing the unit number along with the product code to a slip table; and a step for adding the unit number written to the slip table to product data, which includes a product code corresponding to the unit number, in a third table of a database comprising a first table configured to register product data including a negotiations ID which identifies negotiations; a second table configured to register data of an agreement related to the negotiations, including an agreement ID which identifies the agreement, in association with the negotiations ID; and the third table configured to register data of a product related to the agreement, including a product code which identifies the product, in association with the agreement ID.

### BRIEF DESCRIPTION OF THE DRAWINGS

These objects and other objects and advantages of the present invention will become more apparent upon reading of the following detailed description and the accompanying drawings in which:

FIG. 1 is a diagram illustrating a configuration example of an equipment management system according to an embodiment of the present invention;

FIG. 2 is a block diagram showing the functions of the sales management server and DB server;

FIG. 3 is a schematic diagram that partially extracts the field names of the table group included in the DB server;

FIG. 4 is a table indicating an example of the product operation status and product distribution status included in the product management table;

FIG. 5 is a block diagram for explaining the equipment management function of the equipment management system according to the embodiment;

FIG. 6 is a block diagram for explaining the functions of the ordering CGI of the sales management server;

FIG. 7 is a block diagram for explaining the functions of the slip management server;

FIG. 8 is a diagram showing the relationship between the fields of each table of the DB server;

FIG. 9 is a flowchart illustrating the flow of the operation configured to register the serial number of the equipment in the agreement product/service table and the equipment management table of the sales management server, DB server, and slip management server;

FIG. 10 is a flowchart for explaining the operation of the ordering CGI; and

FIG. 11 is a flowchart for explaining the operation of the slip management program.

### DETAILED DESCRIPTION OF THE PREFERRED EMBODIMENT

The equipment management system according to an embodiment of the present invention is an integrated system that manages “the life of a product,” from negotiations to agreement establishment, equipment product delivery, equipment operation, replacement prevention, and disposal, from business aspects, and supports business operation, etc.

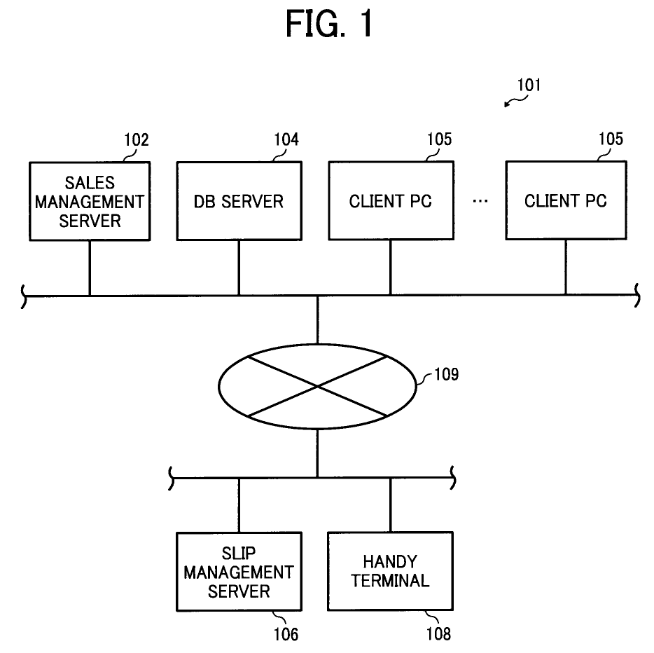

An embodiment of the present invention will now be described with reference to FIG. 1 to FIG. 11. FIG. 1 is a schematic diagram showing an example of the overall equipment management system of the present embodiment. An equipment management system 101 of the present embodiment comprises a sales management server 102, a DB (database) server 104, a client PC (personal computer) 105, a slip management server 106, and a handy terminal 108. These apparatuses are connected via a network 109 such as LAN (Local Area Network) or the Internet.

The client PC 105 comprises a computer comprising a control unit including a CPU, ROM, and RAM, a memory unit including a hard disk device, a communication unit including an NIC (Network Interface Card), router, and modem, an input unit including a keyboard and mouse, and a display unit. The control unit of the client PC 105 realizes a web browser configured to access the sales management server 102 by executing a program stored in the memory unit.

The sales management server 102 comprises a computer comprising a control unit including a CPU, ROM, and RAM, a memory unit including a hard disk device, and a communication unit including an NIC, router, and modem. The control unit of the sales management server 102 realizes a web server program ordering CGI, etc., described later by executing a program stored in the memory unit.

The DB server 104 comprises a computer comprising a control unit including a CPU, ROM, and RAM, a memory unit including a hard disk device, and a communication unit including an NIC, router, and modem. The control unit of the DB server 104 performs processing configured to receive read and write requests to and from the various tables stored in the memory unit from the sales management server 102 and the slip management server 106 by executing the program stored in the memory unit.

Furthermore, at least either the sales management server 102 or the DB server 104 may be realized using a plurality of computers so as to ensure load distribution and safety.

The slip management server 106 comprises a computer comprising a control unit including a CPU, ROM, and RAM, a memory unit including a hard disk device, and a communication unit including an NIC, router, and modem. The control unit of the slip management server 106 realizes a slip management program described later by executing a program stored in the memory unit. Further, a slip table and an inventory control table described later are stored in the memory unit.

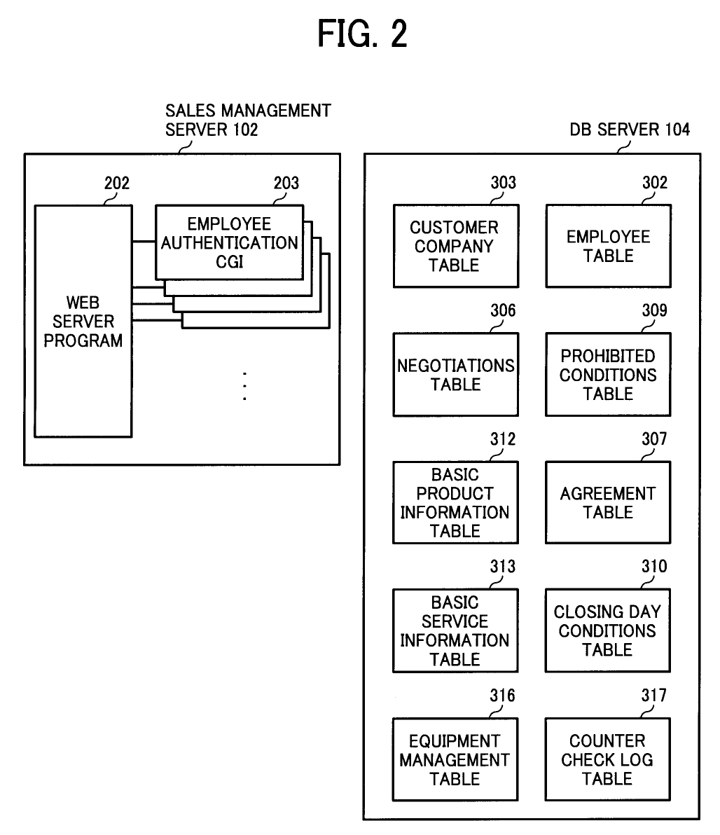

FIG. 2 is a functional block diagram of the sales server 102 and the DB server 104. The sales server 102 comprises a web server program 202 and many CGIs. These CGIs include an employee authentication CGI 203 configured to authenticate those employees permitted to access the system, and a CGI configured to realize the various user interfaces. The DB server 104 stores a great number of tables configured to store various data. FIG. 2 shows a portion of such tables. The DB server 104 comprises an SQL server.

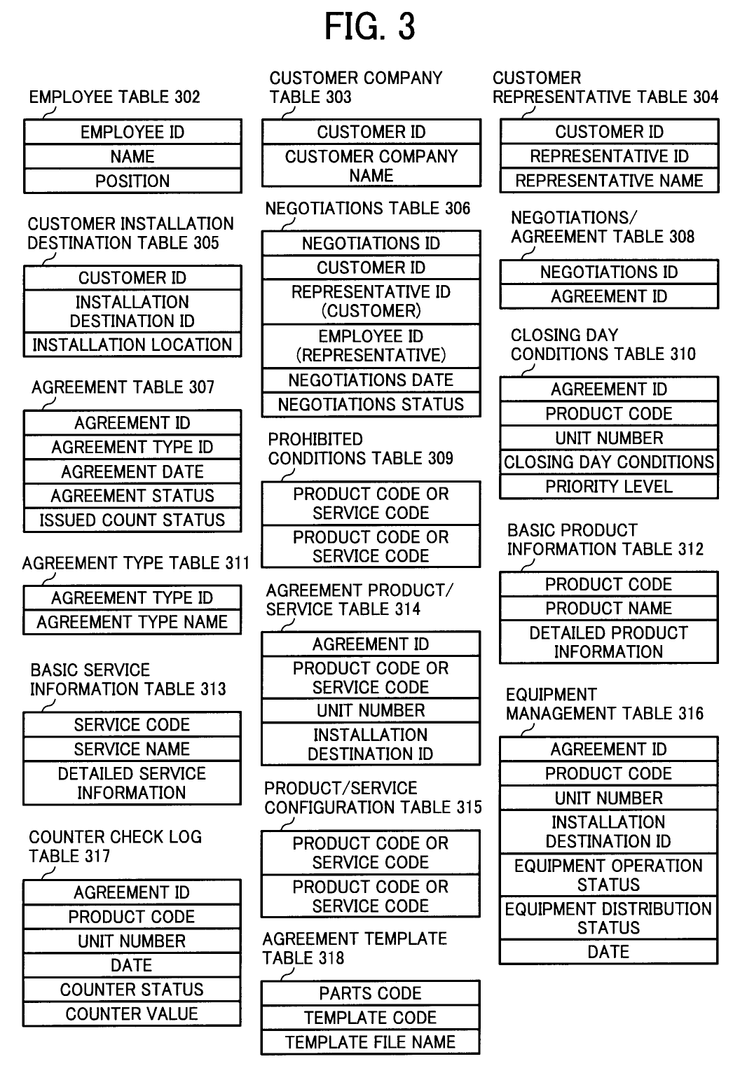

FIG. 3 is a diagram in which the field names of the table group stored in the memory unit of the DB server 104 have been partially extracted. An employee table 302 includes an “Employee ID” configured to uniquely identify an employee, the “Name” and “Position” of the employee, and a hash value (not shown) of the password used for employee login authentication, etc.

A customer company table 303 includes fields such as “Customer ID” which uniquely identifies the customer company, and “Customer Company Name.” In a case where a desired customer company name is to be displayed on the display screen of the client PC 105, the value of the “Customer Company Name” field is acquired from the customer company table 303.

A customer representative table 304 includes fields such as “Representative ID” which uniquely identifies the customer representative, and “Customer ID” which indicates the company of the customer.

A customer installation destination table 305 includes fields such as “Installation Destination ID” which uniquely identifies the installation location (installation destination) when the equipment sold to the customer is to be installed, “Installation Location,” and “Customer ID.”

A negotiations table 306 includes fields such as “Negotiations ID” which uniquely identifies negotiations, “Negotiations Date” which indicates the date negotiations started,” “Negotiations Status” which indicates the progress and result of negotiations (preliminary agreement, agreement established, agreement failed, etc.), “Customer ID,” “Representative ID,” and “Employee ID.” A new record of this negotiations table 306 is created when the sales representative begins negotiations with the customer.

An agreement table 307 includes fields such as “Agreement ID” which uniquely identifies an agreement, “Agreement Type ID,” “Agreement Date” which indicates the date the agreement was concluded, “Agreement Status” which indicates the progress and result of the agreement (preliminary agreement, agreement established, agreement failed, etc.), and “Issued Count Status” which stores the count of agreements formally issued. One record of this agreement table 307 is newly created per agreement.

A negotiations/agreement table 308 comprises groups of “Negotiations ID” and “Agreement ID” values, indicating the relationship between the negotiations and agreements. For example, a plurality of agreements may result from a single negotiation. The negotiations agreement table 308 enables the user to find the negotiations ID from the agreement ID, or the reverse.

A prohibited conditions table 309 describes “product code” and “service code” combinations of products and services that cannot be sold together in a quotation when the sales representative proceeds with negotiations.

A closing day conditions table 310 describes the agreement conditions related to the closing day for checking the counter of equipment, such as a copy machine. The closing day conditions table 310 includes fields such as “Agreement ID” which indicates the agreement affiliated with the equipment, “Product Code” which indicates the product code of the equipment, “Unit Number” which indicates the serial number per equipment, “Closing Day Conditions” which indicates the closing day conditions, and “Priority Level” which indicates the priority level of the “Closing Day Conditions.”

An agreement type table 311 includes fields such as “Agreement Type ID” and “Agreement Type Name.”

A basic product information table 312 includes fields such as “Product Code” which uniquely identifies a product, “Product Name,” and “Detailed Product Information.”

A basic service information table 313 includes fields such as “Service Code” which uniquely identifies a service, “Service Name” and “Detailed Service Information.”

An agreement product/service table 314 describes the relationship between the agreement and products or services. This table comprises groups of “Agreement ID” and “Product Code” or “Service Code” values. For example, a plurality of products or services may arise in a single agreement. This agreement product/service table 314 also includes fields such as “Unit Number” and “Installation Destination ID.”

A product/service configuration table 315 indicates the products and services that make up a product or service, and describes the relationship of the configuration using “Product Code” and “Service Code” values. For example, a copy machine unit comprises a sorter, an automatic double-sided original feeding device, hardware options such as a stapler, software options for achieving a facsimile function, a printer function, and a scanner function, and the like. Furthermore, the copy machine also involves applicable maintenance services. In this manner, a product sometimes includes optional products and services as well. For example, a service that includes the provision of a PC maintenance services and an anti-virus software product may exist under the name “Security Pack.” In this manner, a service sometimes includes a product as well. Such a table, therefore, is provided to describe the configurations of products and/or services.

An equipment management table 316 is a table that plays a core role in the present embodiment. The equipment management table 316 is a table configured to uniquely identify one piece of equipment (one product) using a “Product Code” and “Unit Number,” and manage the life of the equipment from delivery to the customer to disposal or recycling, storing the dates and status information in detail accordingly. The equipment management table 316 includes fields such as “Product Code,” “Unit Number,” “Agreement ID” which indicates the agreement affiliated with the equipment, “Installation Destination ID” which indicates the location in which the equipment is installed, “Equipment Operation Status” and “Equipment Distribution Status” which indicate the status of the equipment, and “Date” which indicates the date on which the various status information was recorded.

A counter check log table 317 mainly records the numeric value of the “counter” that is built into the copy machine and incremented each time the copy machine is used. The copy machine comprises a mechanism for charging for usage in accordance with a usage count, that is the number of sheets consumed by copy output. Here, on the determined closing day of each month, the value of the counter built into the copy machine is checked and stored in the counter check log table 317. The counter check log table 317 includes fields such as “Product Code,” “Unit Number,” “Agreement ID” which indicates the agreement affiliated with the equipment, “Counter Value,” “Counter Status” which indicates the status under which the counter value was acquired, and “Date.”

An agreement template table 318 stores a “Parts Code” configured to identify the model parts required in the agreement, a “Template Code” configured to identify the template, and a “Template File Name.” The model data of the agreement corresponding to the parts code and template code is registered in the agreement template table 318 as a template file. The agreement is created by combining the five parts described below. Note, however, that some parts are required in certain agreements but not in others. The following five parts make up a basic pattern. “Cover sheet”: A part that expresses the agreement relationship between party A and party B. “Basic terms”: A part that expresses the required “basic terms” for the sale. “Service terms”: A part that expresses the basic terms for added value, such as maintenance service, but not for an object (such as a copy machine or PC, for example). “Agreement fee”: A part that expresses the fee at the time of the quotation. “Maintenance details”: A part that expresses what will be serviced in a case where maintenance service is to be subscribed.

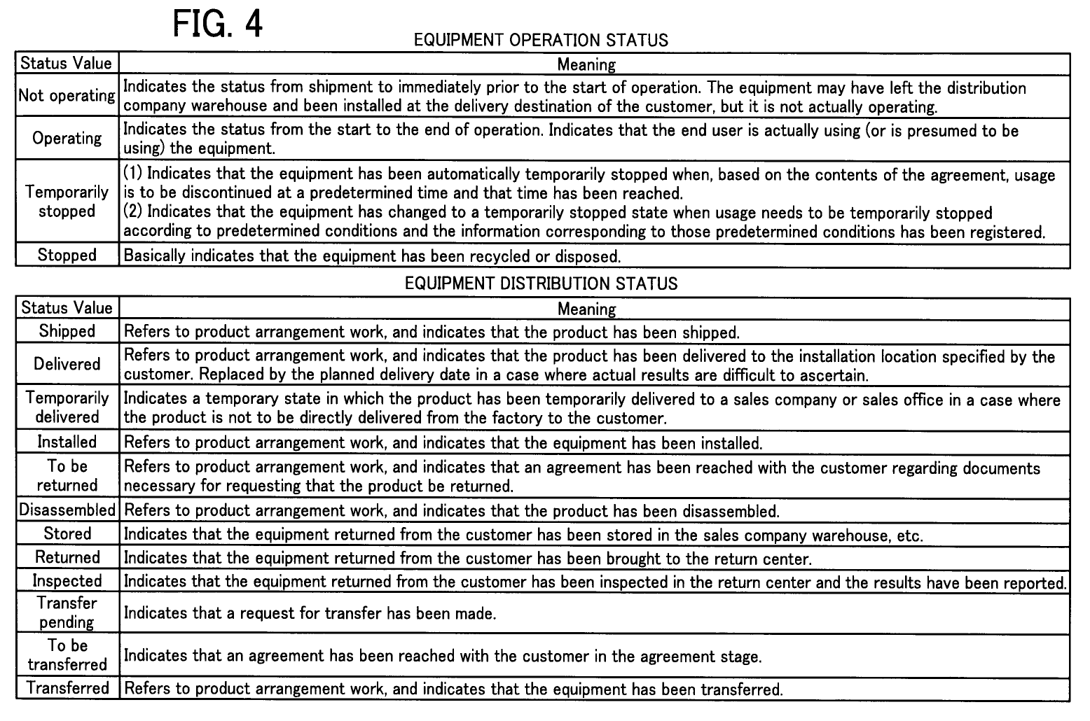

FIG. 4 illustrates an example of the equipment operation status and equipment distribution status included in the equipment management table 316. The equipment operation status indicates the status of the equipment delivered to the customer, and includes the four statuses “not operating,” “operating,” “temporarily stopped,” and “stopped.” The equipment distribution status indicates the location of the equipment delivered to the customer, and includes the 12 statuses “shipped,” “delivered,” “temporarily delivered,” “installed,” “to be returned,” “disassembled,” “stored,” “returned,” “inspected,” “transfer pending,” “to be transferred,” and “transferred.”

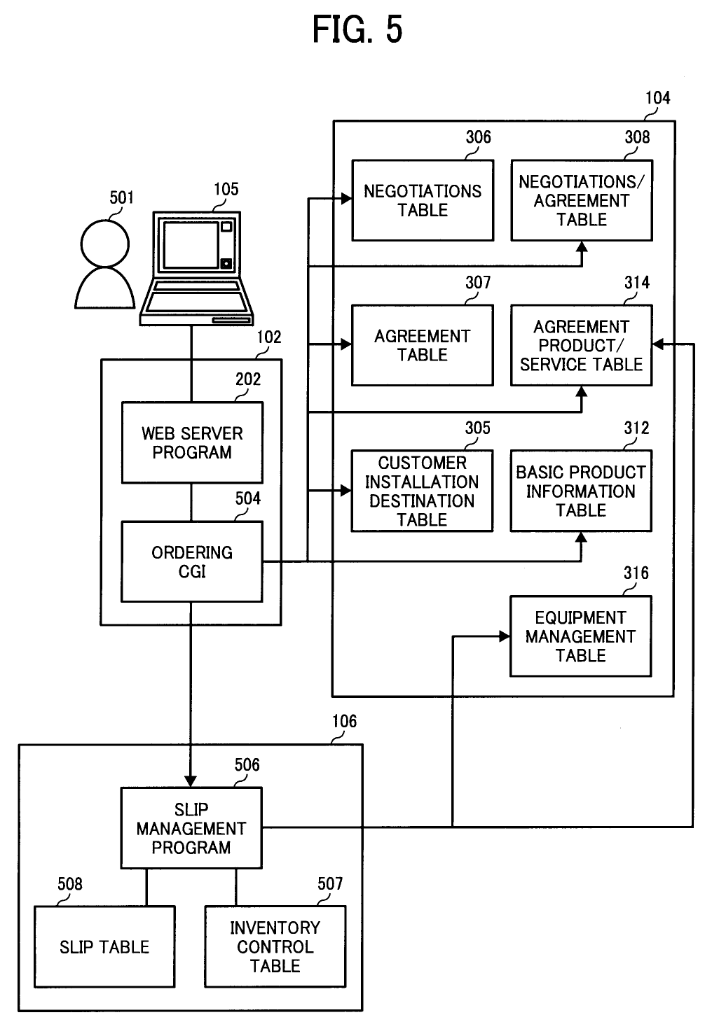

FIG. 5 is a block diagram for explaining the equipment 20 management function, which is one feature of the equipment management system 101 of the present embodiment.

A sales representative 501 at a sales company operates the client PC 105 so as to access the sales management server 102 installed within the sales company. The sales management server 102 25 responds to the access request (HTTP request message) from the client PC 105, and performs predetermined processing. In the predetermined processing, for example, data acquisition and data writing using SQL are performed with the various tables stored within the DB server 104. The arrows that extend from an ordering CGI 504 to each table in FIG. 5 correspond to this processing. The sales management server 102 includes the web server program 202 and the ordering CGI 504. Many additional CGIs also exist, but only those directly related to the present embodiment have been extracted and described in FIG. 5.

The web server program 202 transmits an HTML document or CGI execution result that corresponds to the client request (HTTP request message) received via the network 109, in the format of an HTTP response message. One such message, for example, is Apache (http://www.apache.org/).

The ordering CGI 504 creates an HTML document to be displayed on the web browser of the client PC 105. Further, the ordering CGI 504 includes an SQL client function, accesses each table of the DB server 104, and acquires the desired data. The DB server 104 comprises an SQL server, and has an interactive database engine program configured to read and execute inputted SQL language, and combinations of data file groups that make up the various tables. Additionally, the ordering CGI 504 includes a web client function for the slip management server 106 described later, and transmits order data to a slip management program 506.

The slip management server 106 is installed within the distribution company. The slip management server 106 includes the slip management program 506, an inventory control table 507, and a slip table 508. The slip management program 506 receives the order data issued from the ordering CGI 504, and executes predetermined processing.

The inventory control table 507 stores the product codes and unit numbers of the products housed in the warehouse. The slip table 508 is for issuing and managing slips for each set of order data. The slip table 508 stores the slip number, agreement ID, product code, unit number corresponding to the product code, customer ID, installation destination ID, etc. To avoid information redundancy, the data generated for each slip, such as the slip number, agreement ID, customer ID, and installation destination ID, may be provided in separate tables.

The distribution company owns a warehouse. The warehouse stores products in a packaged state, such as in cardboard boxes. The cardboard box may be provided with a barcode wherein the product code and unit number of the product are recorded, thereby making it possible to directly read the product code and unit number with the handy terminal 108 without removing the packaging. Or, an RFID tag, etc., may be adhered to the product so that the handy terminal 108 or another terminal may receive and transmit the product code and unit number to the slip management server 106 via wireless communication without packaging removal. With this arrangement, the unit number of the product can be inputted to the equipment management system 101 without removing the packaging.

Then, the slip management server 106 receives the order data, quickly identifies the agreement ID in the slip table 508, and transmits and registers the unit number corresponding to the product code included in the order data in the agreement product/service table 314. With such a configuration, management of the ordered product based on the equipment management table 316 begins when a response is to be made to the transmission of order data.

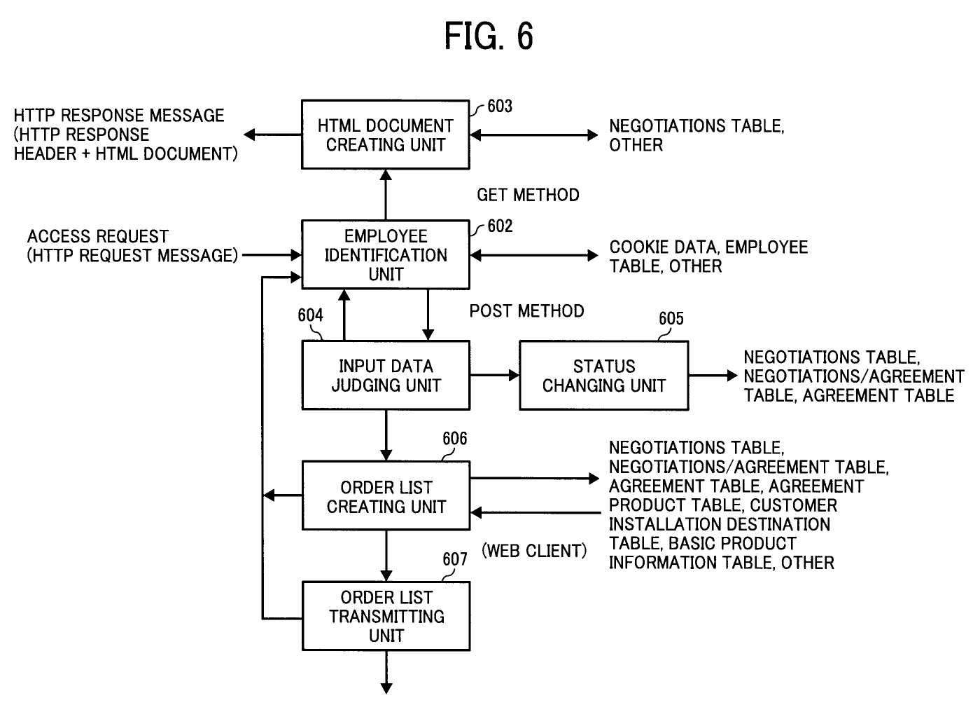

FIG. 6 is a block diagram for explaining the functions of the ordering CGI 504.

An employee identification unit 602 reads the access request (HTTP request message) from the client PC 105, reads the authentication data included in the header area (HTTP request header) of the HTTP request message, refers to the employee table 302, and identifies the employee accessing the system. In the present embodiment, user authentication is based on the widely used cookie authentication. Thus, the employee identification unit 602 verifies the cookie data created by the employee authentication CGI 203, refers to the employee table 302, and identifies the employee.

Further, the employee identification unit 602 reads the HTTP request header to check if the method of the message is a GET method (a message indicating a request to get predetermined data in the HTTP request message) or a POST method (a message indicating transmission of predetermined data in the HTTP request message). If the method is a GET method, the employee identification unit 602 instructs an HTML document creating unit 603 to create and transmit an HTML document to the client PC 105. If the method is a POST method, the employee identification unit 602 reads out the input data transmitted from the client PC 105 to an input data judging unit 604. The input data judging unit 604 verifies the content of the data received from the client PC 105, judges whether or not order processing should be performed and, if so, instructs a status changing unit 605 to write the status information indicating so to the negotiations table 306 and the agreement table 307.

The status changing unit 605 writes the status information indicating “negotiations established” in the negotiations table 306 and the agreement table 307. Furthermore, because a plurality of agreement tables 307 may exist for a single negotiation, the status changing unit 605 refers to the negotiations/agreement table 308 to access the agreement table 307. When the status change processing performed by the status changing unit 605 is completed, the input data judging unit 604 delivers the POST data to an order list creating unit 606.

The order list creating unit 606 accesses the negotiations table 306, the negotiations/agreement table 308, the agreement table 307, the agreement product/service table 314, the customer installation destination table 305, and the basic product information table 312 based on the negotiations ID acquired from the POST data so as to create an order list for transmission to the distribution company. The order list data created by the order list creating unit 606 is delivered to an order list transmitting unit 607. The order list transmitting unit 607 transmits the order list data to the slip management server 106 using HTTP.

In FIG. 6, the arrows drawn from the order list creating unit 606 and the order list transmitting unit 607 toward the employee identification unit 602 indicate the reporting of whether or not the respective processing was brought to a successful conclusion. When the HTTP request message is a POST method and the judgment is made that an order is to be made, the employee identification unit 602 instructs the HTML document creating unit 603 to create an HTML document displaying a message to the client, such as, “Ordering in progress. Please wait.” Next, after successfully creating the order list, the order list creating unit 606 instructs the HTML document creating unit 603 to create an HTML document displaying a message indicating completion, such as, “The order list has been created. Order list transmission will now begin. Please wait.” Lastly, after successfully transmitting the order list, the order list transmitting unit 607 instructs the HTML document creating unit 603 to create an HTML document displaying a message such as, “Order list transmission is completed,” along with a button configured to transfer the screen to the screen prior to order processing.

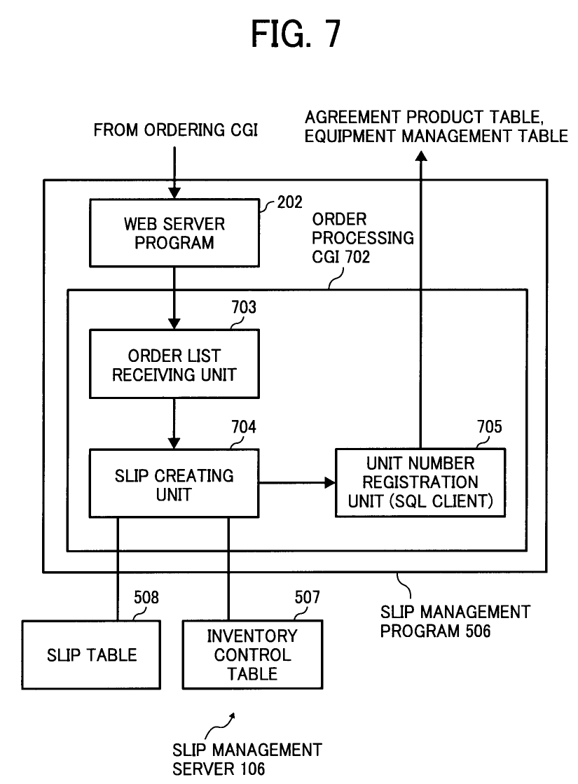

FIG. 7 is a block diagram for explaining the functions of the slip management server 106. The slip management program 506 includes the web server program 202 and an order processing CGI 702. While many other CGIs also exist, those CGIs are not directly related to the present embodiment, and descriptions thereof will be omitted.

The order processing CGI 702 comprises an order list receiving unit 703, a slip creating unit 704, and a unit number registration unit 705. The order list receiving unit 703 receives the order list data transmitted from the ordering CGI 504. The slip creating unit 704 refers to the inventory control table 507 based on the order list data acquired from the order list receiving unit 703, and creates a slip in the slip table 508. Specifically, for a product within the order list data, the slip creating unit 704 links and stores the unit number of the product that exists as inventory in the warehouse in the slip table 508. The unit number registration unit 705 comprises an SQL client configured to access the DB server 104, and registers the unit number of the product within the order list data in a record of the corresponding agreement product/service table 314. Then, the new record is added to the equipment management table 316.

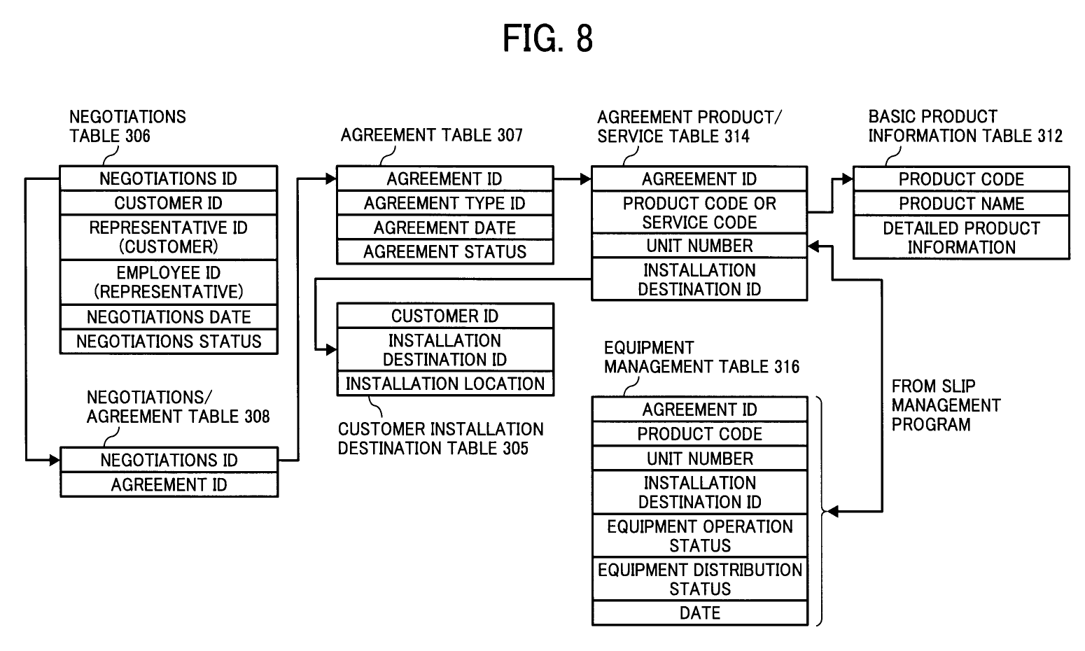

FIG. 8 is a diagram showing the relationship between the fields of each table in the DB server 104 of FIG. 5. The ordering CGI 504 searches the negotiations table 306 using the negotiations ID of the negotiations with the customer as the keyword, and acquires the information related to those negotiations. Next, the ordering CGI 504 searches the negotiations/agreement table 308 using the negotiations ID, and finds one or more agreement ID for corresponding agreements. Next, the ordering CGI 504 searches the agreement table 307 using the agreement ID, and finds the information corresponding to the agreements. Furthermore, the ordering CGI 504 searches the agreement product/service table 314 using the agreement ID, and finds one or more product codes or service codes, and one installation destination ID. Next, the ordering CGI 504 searches the basic product information table 312 using the product code, and finds the information corresponding to the product. Then, the ordering CGI 504 searches the customer installation destination table 305 using the installation destination ID, and finds the information corresponding to the installation destination.

In this manner, data can be acquired with the information of each table linked, making it possible to create a product order list. On the other hand, after the slip management program 506 performs slip creation processing, the unit number is stored in the agreement product/service table 314 and a new record is subsequently added to the equipment management table 316. The content of the added record includes the agreement ID, product code, and installation destination ID acquired from the order data, the unit number acquired when the slip was created, the date this processing was performed, the equipment operation status “not operating,” and the equipment distribution status “shipped.” This addition of a new record is performed correspondingly to the number of products given in the order data. This means that in a case where a certain customer purchases a plurality of identical products (pieces of equipment), a new record is created for each piece of equipment. This is because, even though the equipment may be identical, the unit numbers are each different.

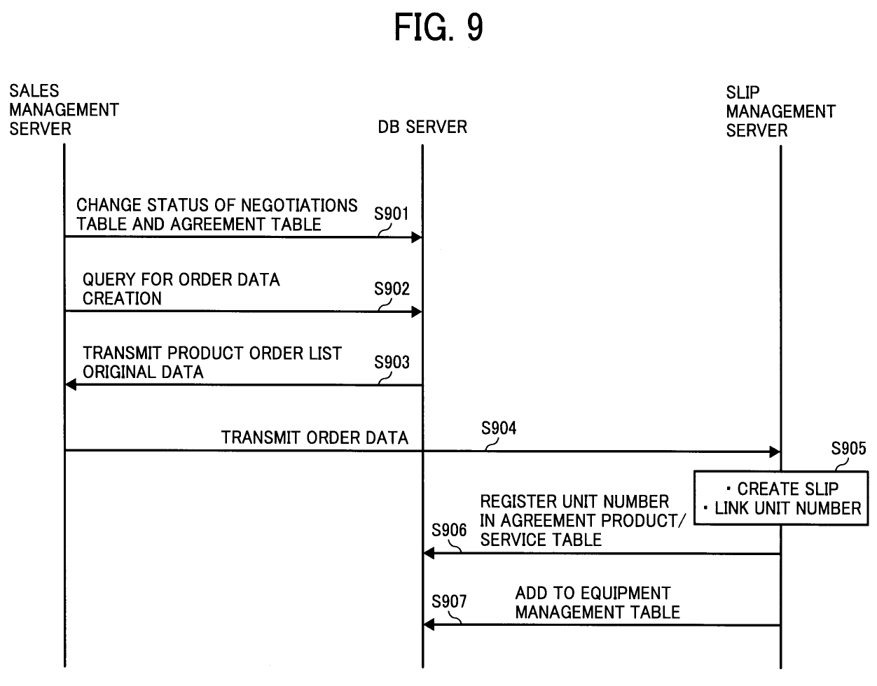

FIG. 9 is a flowchart illustrating the flow of the operation configured to register the unit number in the agreement product/service table 314 and equipment management table 316 of the sales management server 102, the DB server 104, and the slip management server 106.

The ordering CGI 504 of the sales company sales server 102 that received the order instructions from the client PC 105 changes the status of the record of the negotiations table 306 and the agreement table 307 of the DB server 104 (S901). Next, the ordering CGI 504 queries the DB server 104 for order data creation (S902). In response, the data required for creating the order data is transmitted from the DB server 104 to the ordering CGI 504 (S903).

The ordering CGI 504 creates and then transmits the order data to the slip management server 106 (S904).

The slip management program 506 receives the order data, creates a slip, and links the slip with the unit number (S905). The slip management program 506 records the unit number linked to the product code given in the order data in the record of the agreement product/service table 314 (S906). Then, the slip management program 506 adds the record to the equipment management table 316 (S907).

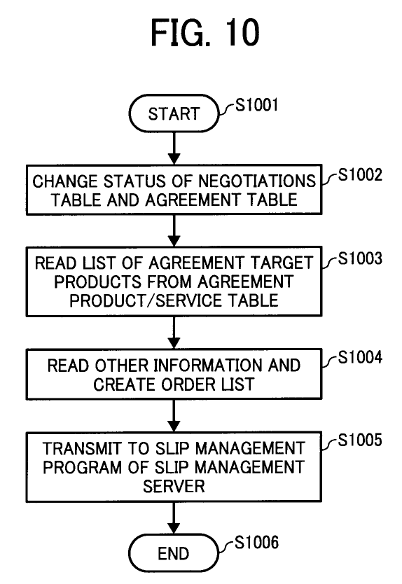

FIG. 10 is a flowchart for explaining the operation of the ordering CGI 504 of the sales management server 102. When activated by the operation of the sales representative 501 (S1001), the ordering CGI 504 first changes the status of the negotiations table 306 and the agreement table 307 to a status value indicating “agreement established” (S1002). Next, the ordering CGI 504 reads the list of agreement target products, that is, the data upon which the order list is based, from the agreement product/service table 314 (S1003). Then, the ordering CGI 504 reads information such as the acquired product code, and creates the order list (S1004). Lastly, the ordering CGI 504 transmits the completed order list to the slip management program 506 of the slip management server 106 of the distribution company (S1005), and ends the processing (S1006).

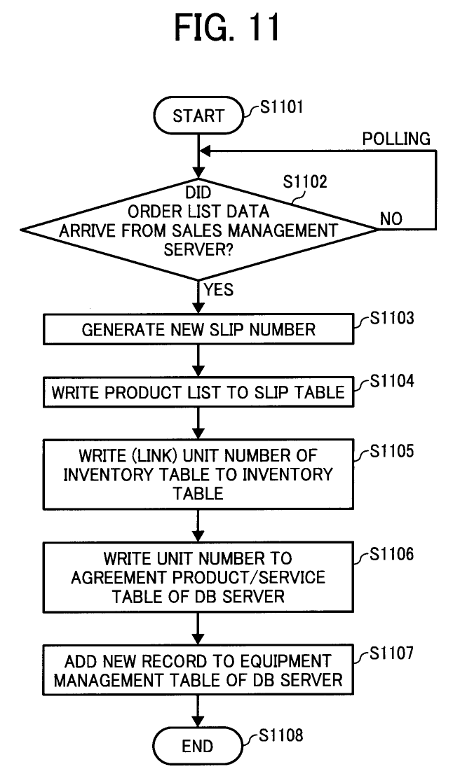

FIG. 11 is a flowchart for explaining the operation of the slip management program 506 of the slip management server 106.

The web server program 202 of the slip management program 506 either receives a transmission of order list data from the sales management server 102 or continues monitoring (S1101, S1102: NO). When the order list receiving unit 703 receives the order list data (S1102: YES), the slip creating unit 704 sets up a new slip number (S1103), and records the product code included in the order list data in a new record of the slip table 508 (S1104). Then, the slip creating unit 704 searches the inventory control table 507 using the product code, and writes the acquired unit number to the slip table 508 so as to link the data (S1105). Preparation for slip creation is now completed. The actual slip at this time is printed using a printer connected with the slip manager server 106 via the network, and outputted. Next, the linked unit number is transmitted to the DB server 104 and recorded in the agreement product/service table 314 (S1106). Then, lastly, the unit number registration unit 705 transmits the agreement ID, product code, and installation destination ID acquired from the order data, the unit number acquired at the time of slip creation, the date of the day this processing was performed, the equipment operation status “not operating,” and the equipment distribution status “shipped” to the DB server 104, records the information in the equipment management table 316 (S1107), and ends the processing (S1108).

Equipment (a product) registered as described above is subsequently uniquely identified by transmitting the product code and unit number to the system. Then, the various status information is added to the equipment management table 316. When the installation location of the equipment changes due to customer circumstances or the equipment is transferred, the installation destination ID of the agreement product/service table 314 is replaced, a new record including the latest installation destination ID and the equipment distribution status indicating that the transfer occurred is added to the equipment management table 316. That is, when a piece of equipment is transferred, a corresponding transfer history log is recorded. The same occurs at the time of equipment disposal or recycling.

The following describes a scenario in which this system is used for the “life of a product,” from business negotiations to agreement establishment, product delivery, product operation, replacement prevention, and disposal.

### Negotiations Support

When a sales representative sells a product to a customer, often a plurality of products and services are sold in combination. For example, in a case where a sales representative sells a corporate information system, equipment such as a server, network equipment, client PC, and software is often sold as a set with corresponding maintenance services. In a case where this service includes products such as software, it is necessary to ensure that the software product sold is not sold in duplicate. For a key client who has purchased a great number of products, it is also necessary to prevent duplication between the products to be sold and the products already purchased, and to prevent the selection of products that cannot be combined together. Thus, the representative uses the client PC 105 to read the past purchase information of the customer from the equipment management table 316 and to read the products that cannot be combined with these from the prohibited conditions table 309, and excludes these items from quotation data.

### Agreement Creation Support

After the quotation is created and presented to the customer, the customer determines whether or not to introduce the system based on the contents and replies to the sales representative. A combination of selectable agreements is presented as a menu according to the product configuration created in the quotation. After the customer selects the desired agreement content, the client PC 105 records the information required to create the agreement, particularly flag information indicating various conditions, in the agreement table 307 according to the input operation of the representative, selectively reads the agreement forms, and automatically creates the agreement. At this time, the condition information of the agreement to be created is written to the closing day condition table 310 according to the equipment to be sold, and used in the counter check follow-up processing based on the counter check log table 317.

### Equipment Management

Once negotiations have been concluded and the product is to be shipped to the customer, the sales representative inputs the conclusion of the negotiations into the system from the client PC 105 via the sales management server 102. The status of the negotiations table 306 is then changed. Further, the product order request data for ordering the product is created based on the agreement table 307 and the agreement product/service table 314, and transmitted to the slip management server 106 managed by the distribution company. When the product order request data is received, the slip management server 106 generates a new slip number in the slip table 508, and records the received product code. Then, the slip management server 106 reads the unit number of the product stored in the inventory control table 507, and records that number in the slip table 508. In this manner, the product code and unit number are associated. The creation of associations between fields common to two or more tables is referred to as “linking.”

Next, the slip management server 106 records the unit number in the agreement product/service table 314 of the DB server 104. Then, the slip management server 106 newly adds a record to the equipment management table 316, and records the status information. In this manner, information indicating that the product has been shipped to the installation destination is recorded in the equipment management table 316, and equipment management begins.

Subsequently, when work such as a certain service is to be carried out, the equipment is specified by inputting the product code and unit number using the client PC 105, etc., and the date and status information is added. Such recording of the equipment status is performed until equipment disposal or elimination by recycling is executed.

### Counter Check

The value of the counter of the copy machine must be checked prior to a certain closing day of each month. However, sometimes the counter value cannot be checked by the closing day by the customer. In such a case, reference is made to the “action conditions” recorded in the closing day condition table 310 created in advance when the agreement is created. The system checks what type of counter check is to be conducted after a certain amount of days has passed since the closing day, and whether or not that work has been successfully completed, and presents appropriate instructions to the representative.

### Replacement Prevention

If the sold equipment is replaced due to a sale made to the customer by another company, the customer is lost. To prevent this from happening, when a lease agreement is to be terminated in an agreement, the representative of the lease company inputs information indicating that an inquiry has been made to the lease company with regard to service charges for lease termination into the system from the client PC 105, etc. Based on this input action, the sales representative is identified from the agreement table 307 and that information is displayed as a warning message when the sales representative accesses the information system from the client PC 105. When that information is inputted from the client PC 105 after a predetermined sales activity is performed, the warning message disappears.

As described above, the equipment management system 101 of the present embodiment responds to a product order and records the product code and unit number that uniquely identify the equipment in the equipment management table, thereby making it possible to record in detail “the life of the product,” from subsequent product operation, to prevention of replacement, and disposal. With this arrangement, “the life of the product” is managed from business operation aspects, and an integrated system that supports business activities, etc., is achieved.

The present invention, however, is not limited to the above-described embodiment and, needless to say, various modifications and changes in application may be made thereunto without departing from the broad spirit and scope of the invention described in the claims.

The storage medium that stores the program and data for achieving the equipment management system of the present invention may be, specifically, a CD-ROM (-R/-RW), magnetic optical disk, DVD-RM, FD, Flash memory, memory card, memory stick, or other ROM or RAM. Then, the storage medium is distributed and the program, etc., is installed in a computer so as to construct the sales company server, slip management server, DB server, etc., that are to execute the above-described processing. The program may also be stored on a disk device of the server apparatus on a network such as the Internet, and downloaded to the computer on carrier waves.

In a case where the above-described functions are realized in part by the OS or by an OS and application combination, etc., simply the section other than the OS may be stored on the medium and distributed, or downloaded to the computer on carrier waves.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2007-089225 filed on Mar. 29, 2007, including specifications, claims, drawings and summary. The disclosure of the above Japanese Patent Application is incorporated herein by reference in its entirety.

What is claimed is:

1. An equipment management system comprising:
a negotiations table configured to include a negotiations ID that uniquely identifies negotiations;
an agreement table configured to include an agreement ID that uniquely identifies one or more agreements associated with one record of said negotiations table;
an agreement product/service table configured to include a product code that uniquely identifies one or more products associated with one record of said negotiations table;
an equipment management table comprising said agreement ID, said product code, a unit number of equipment which is said product, a status of said equipment, and a date as fields;
an ordering unit configured to create order list data that includes said agreement ID and said product code; and
a slip creating unit configured to create slip data from said order list data and link and store said agreement ID, said product code, and said corresponding unit number in said equipment management table.

2. An equipment management system according to claim 1, wherein:
the status of said equipment in said equipment management table includes an equipment operation status that indicates the operation status of equipment, and an equipment distribution status that indicates the transfer status of equipment, and
said equipment management table further includes a field for an installation destination ID that indicates an installation destination of said equipment.

3. An equipment management system comprising a database, a sales management computer, and a slip management computer, wherein:
said database comprises a first table configured to register negotiations data including a negotiations ID that identifies negotiations; a second table that registers data of an agreement related to said negotiations in association with said negotiations ID, said data of an agreement including an agreement ID that identifies the agreement; and a third table that registers data of a product related to said agreement in association with said agreement ID, said data of a product including a product code that identifies the product;
said sales management computer comprises a registration unit configured to register various information related to a product in said database, and a transmitting unit configured to transmit order data, including a product code of an ordered product, to a computer of a distribution company; and
said slip management computer comprises an inventory control table configured to coordinate a unit number and a product code of an inventory product of a distribution company; a slip creating unit configured to respond to the reception of order data, read a unit number corresponding to the product code from said inventory control table, and write said unit number along with said product code to said slip table; and a unit number registration unit configured to add a unit number written to said slip table to product data that includes a product code corresponding to the unit number in said third table.

4. An equipment management system according to claim 3, wherein said product data includes information comprising at least an installation destination of the product, a status indicating the operation status, or a status indicating the distribution status.

5. An equipment management apparatus comprising:
a table configured to register negotiations data including a negotiations ID that identifies negotiations;
a table configured to register data of an agreement related to said negotiations in association with said negotiations ID, said data of an agreement including an agreement ID that identifies the agreement; and
a table configured to register data of a product related to said agreement, including a product code that identifies the product, in association with said agreement ID; wherein:
said product data includes information comprising at least a number of each piece of equipment of the product, an installation destination of the product, a status indicating the operation status, or a status indicating the distribution status.

6. An equipment management method based on a database that stores a negotiations table configured to include a negotiations ID that uniquely identifies negotiations, an agreement table configured to include an agreement ID that uniquely identifies one or more agreements associated with one record of said negotiations table, an agreement product/service table configured to include a product code that uniquely identifies one or more products associated with one record of said agreement table, and an equipment management table comprising said agreement ID, said product code, a unit number of equipment which is said product, a status of said equipment, and a date as fields; comprising:
an ordering step for creating and transmitting order list data that includes said agreement ID and said product code; and
a slip creating step for receiving said order list data, creating slip data from said order list data, and linking and storing said agreement ID, said product code, and said corresponding unit number in said equipment management table.

7. An equipment management method according to claim 6, wherein:
the status of said equipment in said equipment management table includes an equipment operation status that indicates the operation status of equipment, and an equipment distribution status that indicates the transfer status of equipment, and
said equipment management table further includes a field for an installation destination ID that indicates an installation destination of said equipment.

8. A computer readable storage medium that stores a program configured to execute:
a step for responding to the reception of order data that includes a product code of an ordered product, reading a unit number corresponding to the product code from an inventory control table configured to coordinate a unit number and a product code of an inventory product of a distribution company, and writing said unit number along with said product code to a slip table; and
a step for adding a unit number written to said slip table to product data, which includes a product code corresponding to the unit number, to a third table of a database comprising a first table configured to register product data including a negotiations ID which identifies negotiations, a second table configured to register data of an agreement related to said negotiations in association with said negotiations ID, said data of an agreement including an agreement ID which identifies the agreement, and said third table configured to register data of a product related to said agreement in association with said agreement ID, said data of a product including a product code which identifies the product.
